(19) United States
(12) Patent Application Publication
(10) Pub. No.: US 2025/0164173 A1
(43) Pub. Date: May 22, 2025

(54) UNIFIED COOLING UNIT WITH MODULAR STRUCTURE

(71) Applicant: COURAGE TECHNOLOGIES S.L., Puerto de Sagunto Valencia (ES)

(72) Inventors: Ruben Climent Lopez, Valencia (ES); Juan Jose Magraner Benedicto, Valencia (ES); Carmen Roig Bayarri, Valencia (ES)

(21) Appl. No.: 18/835,340

(22) PCT Filed: Feb. 1, 2023
(86) PCT No.: PCT/ES2023/070050

§ 371 Date: Feb. 5, 2025

(30) Foreign Application Priority Data
Feb. 3, 2022 (ES) U202230169

(51) Int. Cl. F25D 11/00; F25B 13/00

(52) U.S. Cl. CPC F25D 11/003; F25B 13/00

(57) ABSTRACT

A refrigeration unit whose main elements are grouped into a block, positioned close to each other, supported by a modular structure that allows housing the batteries, condenser, compressor, and the control elements of the batteries and compressor, each in its own module to be assembled later. All elements are accessible from the exterior. This structure is lightweight and suitable for attachment to the box of a vehicle above the cabin. The structure is covered by a casing that protects both the mentioned elements and the connections between them, with the casing being accessible at each module.

The invention, as its name indicates, refers to a refrigeration unit whose main elements are grouped in a block, close to each other, supported by a modular structure that accommodates the batteries, the condenser, the compressor, and the control elements for the batteries and the compressor. This structure is lightweight and suitable for attachment to the box of a vehicle, all in a balanced manner without compromising stability and providing easy access to each component of the cooling unit.

This results in an autonomous, manageable, and versatile unit that is also environmentally improved.

The technical field to which it belongs is the refrigeration systems for transport vehicles.

### BACKGROUND OF THE INVENTION

The transportation of perishable goods requires vehicle refrigeration systems and equipment that ensure optimal conditions for the products.

These systems are usually powered by the vehicle's engine, which presents the drawback that the vehicle must be running for the refrigeration unit to operate. During long trips, the requirement for the driver to rest necessitates stops where the refrigeration must continue to function. Similarly, in last-mile deliveries, the refrigeration needs to be maintained during the vehicle's stop times required for home deliveries.

One possible solution to keep the refrigeration unit running during vehicle stops is to incorporate an additional engine independent of the vehicle's engine. However, this adds considerable weight to the equipment, increases its cost, and results in extra environmental pollutants compared to other options.

Other systems operate with external batteries, allowing the refrigeration unit to remain operational while the vehicle is stopped. The batteries and their charging systems are located in various parts of the vehicle, posing challenges for installation, maintenance, diagnostics, or repair.

The installation of these drives varies depending on the vehicle, and in some cases, it requires a significant investment of time and resources. Additionally, there are other associated costs, such as specific tools or operations, reworking, or disposal of new parts supplied by the vehicle manufacturer.

Patent literature also includes some documents referring to refrigeration systems that attempt to address these issues.

For example, patent MX2013003680 describes an autonomous refrigeration unit that includes batteries placed in specific parts of the vehicle, as well as various battery recharging systems, such as solar energy.

Patent WO2016/196488 refers to a system for increasing the autonomy of a battery-powered refrigeration system, also including the possibility of recharging via solar energy.

The proposed invention, while within the vehicle refrigeration systems sector, focuses on other objectives, as indicated below.

### DESCRIPTION OF THE INVENTION

The proposed invention aims to achieve:

A versatile refrigeration unit where the cooling unit—including batteries, compressor, condenser, and control electronics—is grouped into a compact modular chest, and the evaporators can be distributed within the vehicle's box according to the needs of different cooling zones.

This arrangement aims for easy integration into the vehicle since the pre-assembly can be carried out in a workshop, and its installation in the vehicle is quick, preventing the vehicle from being inoperative for several days.

Additionally, grouping the various components shortens the length of the connections between them, reducing both the cost and weight of the connection ducts and decreasing the amount of gas required in the circuit. Therefore, in the event of a leak, the environmental impact is minimised.

The proposed unified cooling unit also facilitates repair operations for two main reasons. First, the arrangement of each component within the structure allows for easy access. Secondly, in the event of a severe failure, the entire unit can be dismantled and replaced, or if a failure affects only one module, that module can be dismantled and replaced, thereby reducing the time the vehicle is inoperative.

The unified design eliminates the need to access different parts of the vehicle to check the functioning of individual components or replace an element.

Another advantage is that, being pre-assembled and unified, the number of parts, connections, and mounts is reduced, thereby decreasing the risk of errors and avoiding interventions in different parts of the vehicle.

Another objective of the invention is that any issue can be quickly detected and repaired, which is achieved by having the cooling unit unified and visible.

In addition to reducing the length of connections between elements of the cooling unit located in the structure, by positioning it over the cabin, the length of connections between the cooling unit and the user interface or battery charging elements is shortened; including solar panels, electric generators, or mains connections, among others.

The intended cooling unit comprises:
A) A chest that in turn includes:
   A modular structure suitable for housing and securing a plurality of components within it, including:
      A condensing unit.
      Batteries, preferably centred, located in the rear part of the structure so that their weight minimally affects the equipment and the axle weight distribution of the vehicle
      A compressor located on one side, in a specific recess. The compressor is variable speed and includes dampers, minimizing the transmission of noise and vibrations to the rest of the components and the structure. The compressor is connected to the rest of the equipment via flexible tubing, thus decoupling any possible vibrations from the rest of the system.
      An electronic management unit for the compressor, preferably housed in the same recess as the compressor.
      An electrical management unit for the batteries, preferably housed in a lateral recess adjacent to the batteries.
      A series of connections between the various components.
B) One or more evaporator units connected to the chest. The evaporator units are placed inside the vehicle's box, in the desired location and orientation, allowing for different temperature zones to be created. The machining required in the vehicle box for the connections between the chest and the evaporator units is limited to enabling the passage of these connections, so a hole that allows for the passage of their section is sufficient.
C) External connections:
   Connection with the control interface located in the cabin, allowing the user to control the refrigeration unit.
   External connection for recharging the batteries, which can come from any recharging system such as a generator, solar panel, the vehicle's engine battery, electrical grid, or any other source.

The structure of the chest is modular, so the various components can be pre-assembled in their corresponding recess or module, and these recesses or modules can be assembled together at a later stage. This allows for the simultaneous construction, stocking of independent modules, and, in the event of a failure, their replacement, thus speeding up repair times. Preferably, the modules are joined together by removable means such as screws, complementary geometries, or any other method.

All modules or recesses have windows to the outside of the structure, allowing easy access to the interior and the components they house.

The structure is covered by a casing that has accessible areas for each recess, preferably coinciding with the windows. We will refer to accessible areas as each specific zone of the casing that can be moved or removed from its position, allowing access to the interior of the chest.

In a preferred embodiment, the casing comprises independent panels, attached to the structure by removable means. Each panel may have a distinct morphology based on the necessary characteristics to cover each area.

Also in a preferred embodiment, the distribution of the various components and modules is arranged as follows, taking the cooling unit as viewed from the front of the vehicle:

The main module, in a central position, includes a transverse partition that divides it into two recesses, one front and one rear.

The batteries, either 24V or 48V, are housed in the rear recess, close to the vehicle's box and in a central position, thus favouring the load distribution of the cooling unit and greater stability of the set. The condensing unit is housed in the front recess to promote airflow.

On one side of this central module, preferably on the left, there is a lateral frame, anchored to the transverse partition, that defines a recess, which we will call the left recess, housing the electrical management elements of the batteries.

On the opposite side is the compressor module with a recess, which we will call the right recess, that houses the compressor, dampers, the electronic management unit of the compressor, and the connections between them. The compressor is a variable voltage (24V or 48V) and variable speed unit, powered directly by the batteries.

In the preferred embodiment being described, the structure comprises a series of windows that connect the exterior with each of the recesses:
The rear recess has a top window to facilitate access to the batteries.
The front recess has a clear front-top window.
The left recess has a window open to the left side of the chest.
The right recess has several windows: a front window, one open to the right side of the chest, and a top window to facilitate access to the various refrigeration components.

The components must be easily accessible from the outside once the panel covering them is moved or removed.

Therefore, the elements within the recess that houses them are positioned close to an access window and without any connections or devices interposed between each component and the exterior. All connections are routed internally within the modules.

The central partition protects the batteries, contributes to the rigidity of the assembly, allowing the front-top window to be clear, and provides support for the lateral frame anchorage and assists in anchoring the compressor module.

In this way, a rigid, lightweight assembly with a minimal structure and large windows is achieved, allowing easy access to each component in case of a failure.

In one possible embodiment, the structure may feature an independent solid bottom closure separate from the bottom closure that each module or recess might have, and a solid rear closure with cut-outs in some parts to lighten the assembly.

To better understand the invention, the following figures are presented.

### BRIEF DESCRIPTION OF THE FIGURES

FIG. 1 shows the cooling unit (1) without the outer casing, where the structure (2) can be seen, comprising a central module (16) with the rear recess (3) where the batteries (4) are located, the front recess (5) where the condenser (6) is located, the module with the right recess (7) where the compressor (8) is located together with other electronic elements for its management, and a frame (22) that delimits a left recess where the electrical elements for battery management are located.

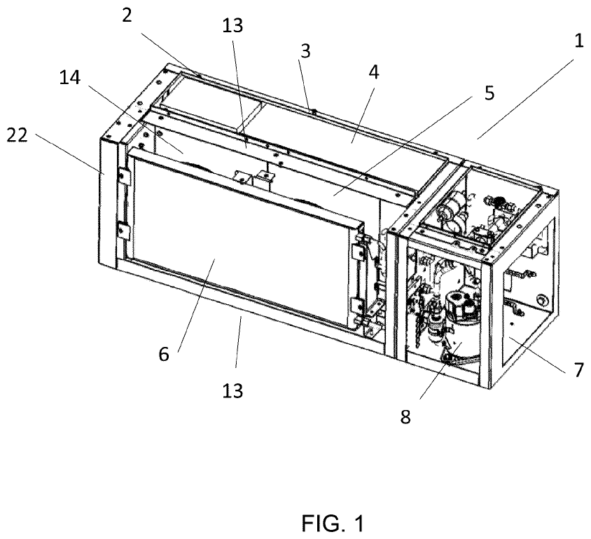

The structure comprises a transverse partition (13) that divides the central module into a front and a rear opening and allows the front window (14) of the front module to be diaphanous, i.e., no element obstructs or crosses it.

FIG. 2 shows the cooling unit without the outer casing, from another perspective, where the left recess (9), the frame (22) that delimits it and that is anchored to the transverse partition (13), can be seen in more detail. The management elements (10) of the batteries (4) can also be seen.

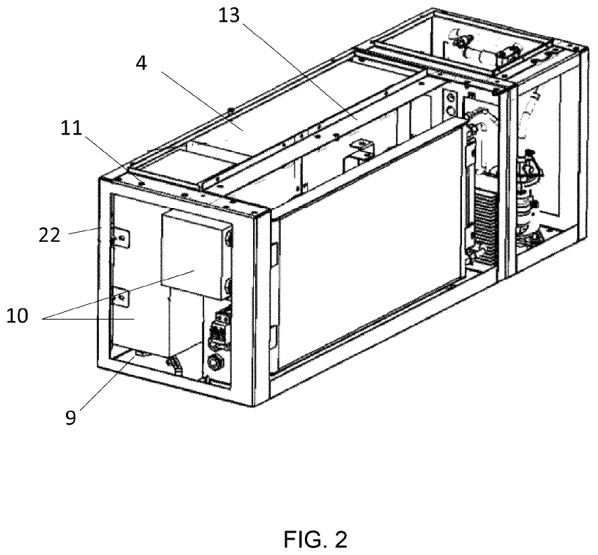

Anchoring elements (11) for fixing the removable panels are also visible.

FIG. 3 shows the exploded view of the central module (16) and the module with the right recess (7).

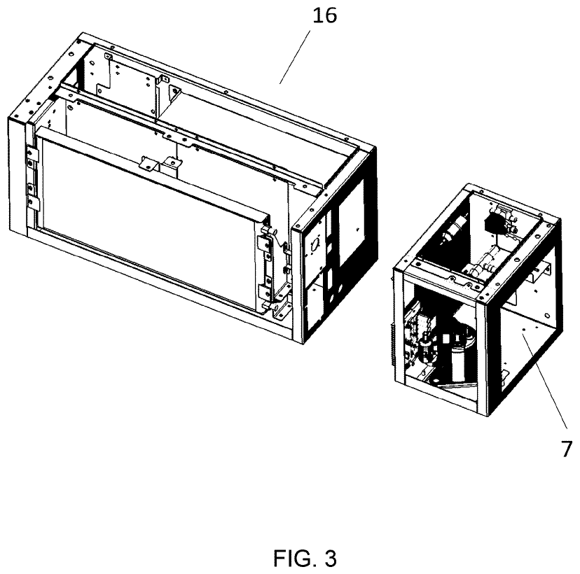

FIG. 4 shows in explosion different components and elements of the unit, thus we see the central module (16) with a rear hole (3), a front recess (5) and a transverse partition (13), the frame (22) that delimits the left hole and the module of the right recess (7). All the openings have windows to the outside and the different modules are connected to each other by removable means. The batteries (4), the condenser (6), the compressor (8), the electronic elements of compressor management, the electrical elements of battery management (10), all of them housed in the structure, can also be seen.

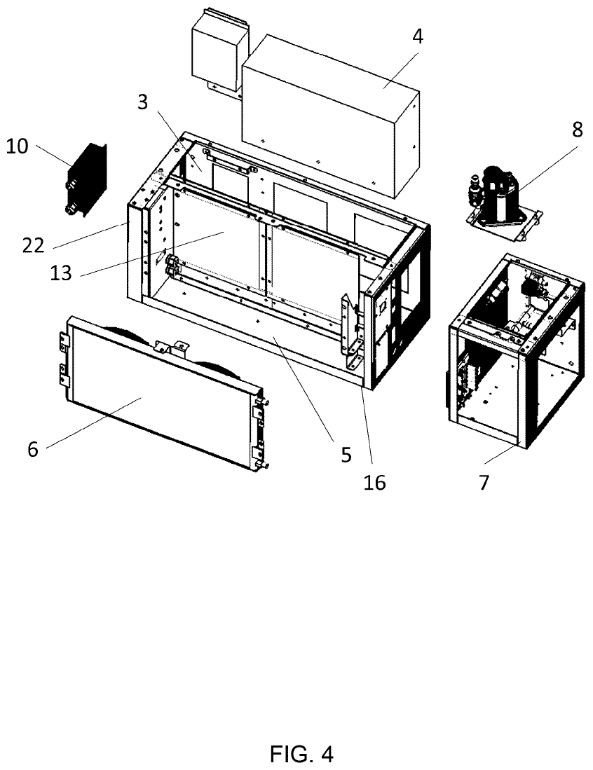

FIG. 5 shows an exploded view of the panels that cover the structure and make up the casing, some of them perforated. Thus we see the side panels (17) that cover the side windows of the left and right side windows, the front panel (18) that covers the entire front of the structure, the upper right panel (19) that covers the upper right side windows, the rear panel (20) and the front panel (21), both upper panels.

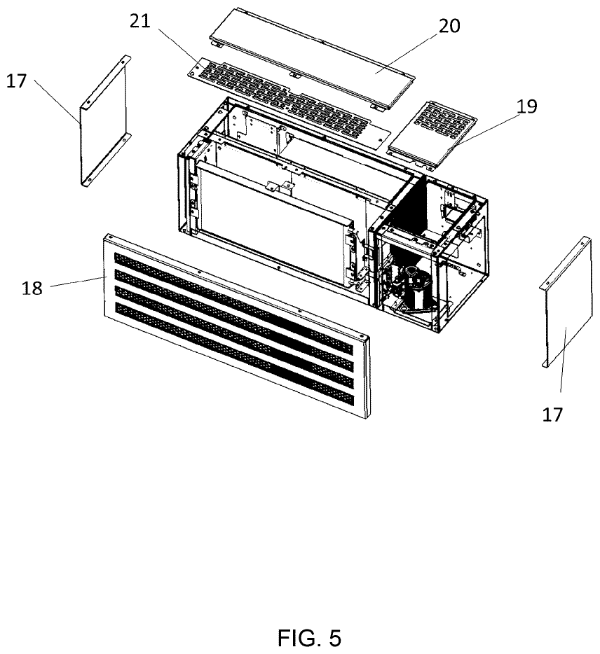

FIG. 6 shows the cooling unit (1) mounted on a vehicle (12) where the evaporators (15) arranged inside the truck body can also be seen, generating, in this case, two different cooling zones.

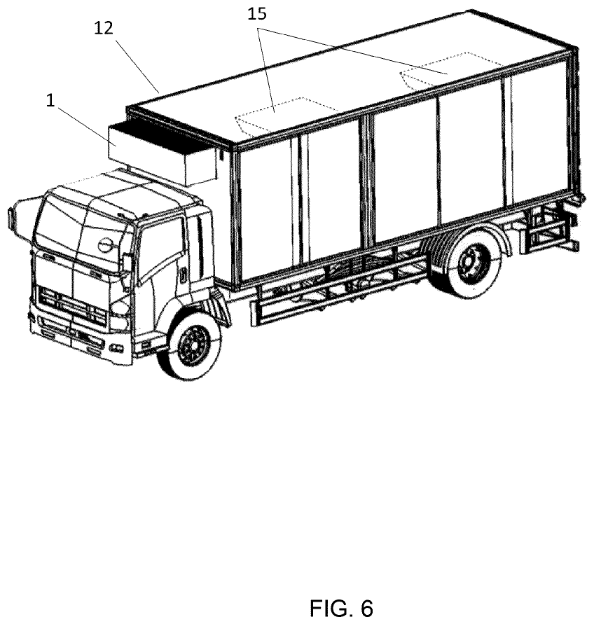

### DESCRIPTION OF AN EMBODIMENT

The following describes a way to implement the invention, which is neither unique nor limiting, but simply explanatory.

The unified cooling unit according to the intended invention comprises:

A modular structure (2) that supports the components, which are the condenser (6), batteries (4), battery management elements (10), compressor (8), compressor electronic management elements, and the connections between them.

The structure includes a central module that comprises the rear recess (3) where the batteries (4) are centrally located, and the front recess (5) where the condenser (6) is located. This central module also has a transverse partition (13) that divides it into front and rear recesses and protects the batteries.

Additionally, the structure includes a module with a right recess (7) where the compressor (8) is located along with other electronic management elements, and a left recess (9) where the battery management elements (10) are located

The various modules and recesses are connected to each other through screws, forming a prismatic block. The prismatic shape of the structure and the modules facilitates their manufacture using standard profiles and market pieces.

Each recess has windows to the exterior, and the structure, once assembled, has windows at least on its front, sides, and top.

The chest is covered by a protective casing that comprises a plurality of panels, each covering a specific area.

The side panels (17) cover the side windows of the left and right recesses, the front panel (18) covers the entire front part of the structure, the top right panel (19) covers the top of the right recess, the rear (20) and front (21) upper panels respectively cover the top of the rear and front recesses.

These panels are attached to the structure with screws or fastening knobs, making them easily removable. The regular shape of the panels, whether rectangular or square, simplifies their construction as special molds or complex machining are not required.

By allowing the independent removal of each panel, access is provided only to the recess housing the component that needs attention, without needing to disassemble the entire casing. This avoids excessive work and prevents exposing other modules or elements that do not require access.

The modular nature of the casing allows for the use of different materials, thicknesses, or constructions for the panels, adapting each panel to its purpose and function. Some panels can be solid sheets (17) and (20), others may have slotted designs (19) and (21), and others can feature perforated sections with a grille (18).

The compressor (8), with dual speed and variable voltage, is mounted on dampers to prevent vibrations. Similarly, it is connected to the other components through a flexible connection to decouple any potential vibrations. This compressor is powered directly by the batteries, in this case, 24V.

The compressor (8) is located in the right recess (7) in an accessible housing.

A component is said to be in an accessible housing when there are no parts or connections between it and the exterior, once the corresponding panel is removed, that could hinder access.

The condenser (6) is placed in the front recess (5) and is accessible from the front-top window (14).

The condenser is located close to the compressor (8) to shorten the length of the connections between them, reducing the amount of gas in the circuit. This results in lower costs for parts, assembly, and maintenance and, in the event of a leak, minimises environmental damage. The reduction of refrigerant gas in the circuit is further enhanced by using an aluminum microchannel configuration for the condenser coil.

In the left recess (9), the battery management elements (10) are located in an accessible housing from the exterior window of the left recess. This left recess is delimited by a frame (22) attached to the central partition (13).

The batteries (4), placed in the rear recess (3) in an accessible housing from the top window of the rear recess, are positioned centrally and as close as possible to the wall of the vehicle's box, thus favouring load distribution and the force behaviour of the assembly.

As described, all elements are arranged to ensure easy access, and the structure has windows of sufficient size to allow the removal of each element without needing to disassemble the entire assembly. This design maintains the solidity and strength of the structure while keeping it lightweight.

All modules and recesses have a quadrangular prism shape with windows on their exterior sides. The assembly formed by the union of all modules and recesses also forms a quadrangular prism.

The cooling unit features a series of external connections, including:
Connection with one or more evaporator units located inside the vehicle's box. The connection with the evaporator units is made by means of flexible pipe, facilitating the installation and minimising the possibilities of leakage.
Connection with the control interface located in the cabin, allowing the user to control the refrigeration unit. From the electrical interface zone of the equipment and electronic control, the only electrical interface with the driver's cabin is routed via a communication cable between the cabin's electrical control and the human-machine interface, typically mounted on the vehicle's dashboard.
   External connection for recharging the batteries, which can come from any recharging system, such as:
      External connection for solar panels: these come from the roof of the vehicle, where the solar panels are located, making the routing short and straightforward.
      External connection to the electrical grid: an interface is usually prepared on the side of the vehicle to allow connection to the grid.
      Motor battery, through a cable connected from the motor battery to the recharging electrical control module in the equipment

1. UNIFIED COOLING UNIT WITH MODULAR STRUCTURE suitable for installation in a vehicle, attached to the wall of its box in a chest over the cabin, comprising a structure suitable for housing the batteries (4), the condenser (6), the compressor (8), the electronic management elements of the compressor, the electrical management elements of the batteries (10), and characterized in that this structure also houses all the connections between all the aforementioned elements, all of which are arranged in an accessible manner. The structure comprises a central module (16) with a rear recess (3), a front recess (5), and a transverse partition (13). On the sides of this central module, there is a module with a left recess (9) and a module with a right recess (7). All recesses have windows to the exterior, and the various modules are joined together by removable means. This structure is enclosed by a casing with at least one accessible area for each recess and includes connections with at least one evaporator (15).

2. UNIFIED COOLING UNIT WITH MODULAR STRUCTURE according to claim 1 characterised in that the batteries (4) are arranged in the rear recess (3), the condenser (6) in the front recess (5), the compressor (8) and the electronic elements of compressor management in the right recess (7) and the electrical elements of battery management (10) in the left recess (9).

3. UNIFIED COOLING UNIT WITH MODULAR STRUCTURE according to claim 1 characterised in that the casing comprises removable window closing panels.

4. UNIFIED COOLING UNIT WITH MODULAR STRUCTURE according to claim 1 characterised in that the at least one evaporator (15) is arranged in the vehicle housing.

5. UNIFIED COOLING UNIT WITH MODULAR STRUCTURE according to claim 1 characterised in that the structure is in the form of a quadrangular prism and each of the modules is in turn in the form of a quadrangular prism.

6. UNIFIED COOLING UNIT WITH MODULAR STRUCTURE according to claim 1, characterised in that the left opening (9) is delimited by a frame (22) connected to the central partition (13).

7. UNIFIED COOLING UNIT WITH MODULAR STRUCTURE according to claim 1, characterised in that the central module (16) includes an open front window (14).

8. UNIFIED COOLING UNIT WITH MODULAR STRUCTURE according to claim 1 characterised in that the compressor is of variable speed and variable voltage.

9. UNIFIED COOLING UNIT WITH MODULAR STRUCTURE according to claim 1, characterized in that it also includes an external connection for recharging the batteries.

10. UNIFIED COOLING UNIT WITH MODULAR STRUCTURE according to claim 1, characterized in that it also includes an external connection to the control interface in the cabin.
